(19) United States
(12) Patent Application Publication
(10) Pub. No.: US 2026/0259747 A1
(43) Pub. Date: Sep. 3, 2026

(54) ADAPTIVE TEXT SCALING FOR VISUAL ACCESSIBILITY ON SELF-SERVICE TERMINALS (SSTs)

(71) Applicant: NCR Voyix Corporation, Atlanta, GA (US)

(72) Inventors: Kip Oliver Morgan, Atlanta, GA (US); Gina Torcivia Bennett, Lawrenceville, GA (US); WuChieh James Jong, Raleigh, NC (US); Hariprasad Kasavajjala, Khammam (IN); Erfan Khaki, Alpharetta, GA (US); Addison Sage Benson, Atlanta, GA (US)

(21) Appl. No.: 19/067,311

(22) Filed: Feb. 28, 2025

(51) Int. Cl. G06F 9/451; G06F 3/04845; G06F 40/109

(52) U.S. Cl. CPC G06F 9/451; G06F 3/04845; G06F 40/109

(57) ABSTRACT

Methods and system for dynamically scaling text on self-service terminals to accommodate visually impaired users while maintaining application usability. The system employs metadata tags to designate expandable screen regions, non-essential elements, and text truncation rules. When a user selects an accessibility option, the interface dynamically transforms screen elements according to predefined rules that determine how text can grow within space constraints. The system applies intelligent truncation rules that maintain word comprehension while maximizing text size, and groups related interface elements to ensure consistent scaling. Screen elements are organized using metadata that indicates directional growth capabilities and element importance, enabling the system to hide non-essential elements when needed. This approach enables legacy self-service systems to meet modern accessibility requirements while preserving application functionality and user experience.

### BACKGROUND

Self-service software applications, particularly those used in retail and banking environments, face significant challenges in meeting accessibility requirements for visually impaired users. Due to space constraints on interface screens and legal requirements in various regions, including new laws forming in the European Union (EU), these applications must accommodate larger text sizes for better readability. However, simply increasing text size can make applications unusable, as screens have limited space and text typically runs out of room horizontally before vertically. These challenges are particularly acute in self-service kiosks or checkouts where small text can make them difficult to use for visually impaired individuals, potentially leading to legal compliance issues.

### BRIEF DESCRIPTION OF THE DRAWINGS

FIG. 1A is a diagram of a system for adaptive text scaling for visual accessibility on Self-Service Terminals (SSTs), according to an example embodiment.

FIG. 1B is a flow diagram for truncating words in screens of a transaction interface, according to an embodiment.

FIG. 1C is an example interface screen illustrating text that is capable of being scaled up in size in a single direction within the screen, according to an example embodiment.

FIG. 1D is an example interface screen illustrating groupings of text for which text sizes within each grouping includes same font size as a largest measurable text size within a corresponding grouping, according to an example embodiment.

FIG. 2 is a flow diagram of a method for adaptive text scaling for visual accessibility on SSTs, according to an example embodiment.

FIG. 3 is a flow diagram of another method adaptive text scaling for visual accessibility on SSTs, according to an example embodiment.

### DETAILED DESCRIPTION

Self-service terminals (SSTs) face unique challenges when accommodating visually impaired users. While some text elements, such as prices, weights, and item descriptions, already meet minimum legal requirements due to Weights and Measures restrictions, other interface elements require adaptation. Many countries require a minimum font size of 9.5 mm as a minimum standard for sight impairment accessibility. Typical SST interfaces utilize a three-column layout, which creates inherent space limitations when text sizes need to increase. Traditional approaches to text scaling often result in truncated words becoming incomprehensible, and maintaining consistent sizing across grouped interface elements poses significant design challenges.

In an embodiment presented herein, the methods and systems employ metadata tags to designate how screen regions can expand in different directions—east (right), west (left), south (down), or north (up). These metadata indicators also identify which screen elements, such as icons or words, are mandatory or optional, and specify truncation rules for individual elements (e.g., whether a word is permissibly truncated or not, etc.). When a customer selects an accessibility option on the transaction terminal's touch display relative to sight accessibility, the interface dynamically transforms according to the metadata tags, flags, and predefined rules.

The transformation process implements specific text scaling rules that preserve readability while maximizing available space. For example, when text has space to grow in a single direction, such as the “Search or key in item” text on a button with space above it, the methods and system can expand the text upward while potentially hiding non-essential elements like icons. The methods and system apply intelligent truncation rules that ensure no word is reduced below three letters in any language, replacing removed letters with an ellipsis to maintain comprehension.

For grouped interface elements, such as picklist tabs and system function buttons that appear in a row, the methods and system maintain consistent sizing through shared panel controls or metadata grouping tags. The largest measurable text within a group dictates the font size for all elements in that group, ensuring visual consistency and readability. Additionally, the methods and system accommodate branding requirements by utilizing the smallest allowable footprint for logos and branding elements, enabling efficient space utilization while maintaining corporate identity standards.

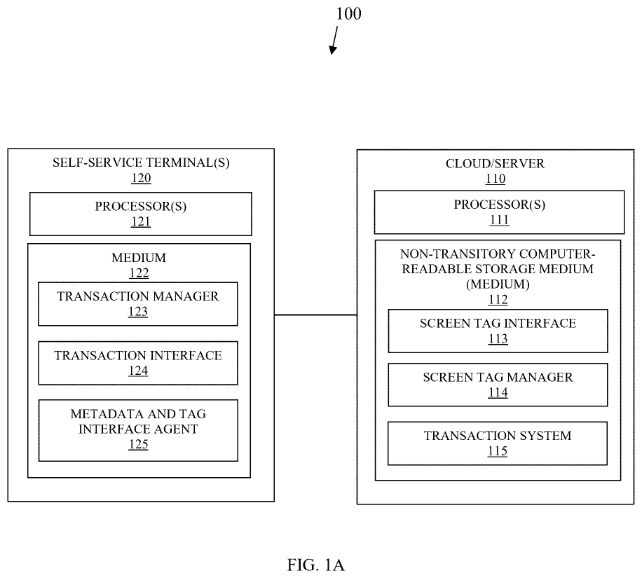

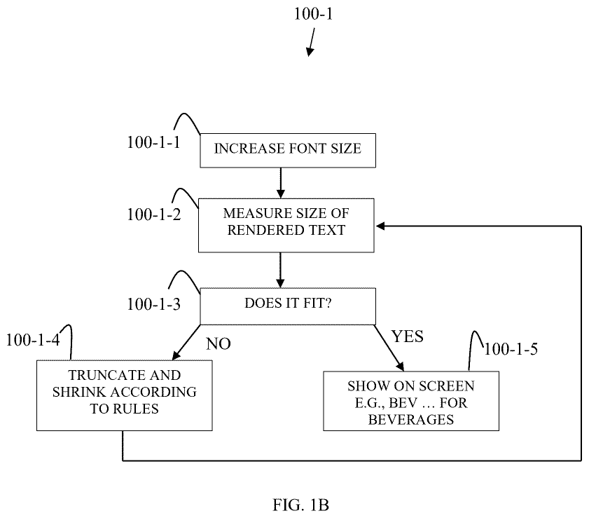

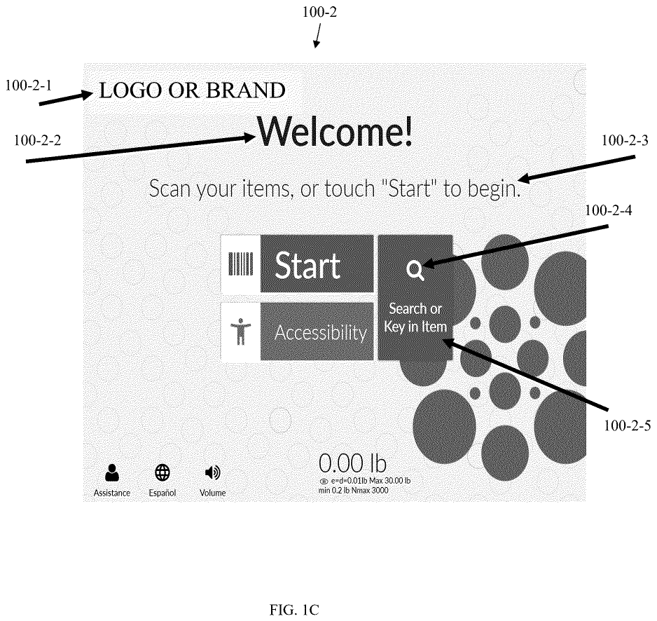

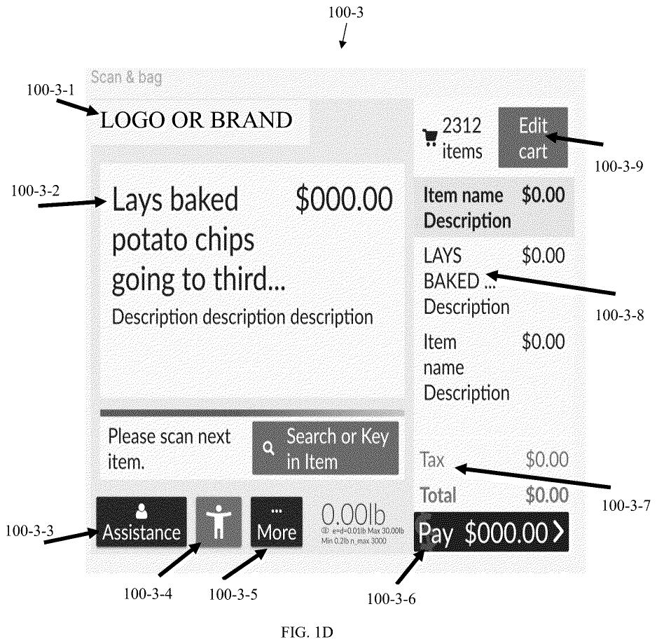

FIG. 1A is a diagram of a system 100 for adaptive text scaling for visual accessibility on SSTs, according to an example embodiment. Notably, the components are shown schematically in greatly simplified form, with only those components relevant to understanding of the embodiments being illustrated.

Furthermore, the various components (that are identified in system 100) are illustrated and the arrangement of the components are presented for purposes of illustration only. It is to be noted that other arrangements with more or less components are possible without departing from the teachings of adaptive text scaling for visual accessibility on SSTs, presented herein and below.

System 100 includes a cloud 110 or server, one or more SSTs 120. Cloud 110 includes at least one processor 111 and a non-transitory computer-readable storage medium 112 (medium), which includes instructions for a screen tag interface 113, a screen tag manager 114, and a transaction system 115. The instructions when executed by the processor 111 cause the processor 111 to perform operations discussed herein and below with respect to 113-115.

Each SST 120 includes at least one processor 121 and a medium 122, which includes instructions for a transaction manager 123, a transaction interface 124, and a metadata and tag interface agent 125. The instructions when executed by the processor 121 cause the processor 121 to perform the operations discussed herein and below with respect to 123-125.

The transaction manager 123 presents a transaction interface 124 for starting and completing transactions on the SST 120. The transaction interface presents screens of interface elements based on states of the transaction. A customer's interaction with and input selections provided to the transaction interface 124 cause transaction manager 123 to change the states of the transaction. The transaction manager 123 interacts with transaction system 115 to process transactions at the SST 120.

Initially, screen data for the transaction interface 124 is analyzed using screen tag interface 113. Groupings of interface elements within a screen are tagged and metadata is added to indicate whether a given grouping can be expanded to accommodate larger font sizes or text sizes in four directions, east (right), west (left), north (up), and south (down). The metadata and/or tags can also indicate whether an interface element is mandatory or optional. Still further, metadata and/or tags can indicate whether truncation rules are permitted or not.

The screen tag manager 114 provides tagged screen data with metadata to the metadata and tag interface agent 125. Transaction manager 123 reports when a customer selects an accessibility option for visual accessibility to metadata and tag interface agent 125. Metadata and tag interface agent 125 dynamically causes scaling and positioning of interface elements to change for the screens rendered by the transaction interface 124 during the customer's transaction based on the tagged screen data with metadata associated with each screen.

The screen tag manager 114 performs initial testing of interface element sizes by rendering and measuring text in an off-screen location before applying any transformations to the actual interface. This testing process allows the screen tag manager 114 to determine the precise measurements needed for each interface element when scaled to larger sizes, evaluate space constraints, and verify that truncation rules will produce readable results. The testing includes measuring the rendered size of each word at the target font size of 9.5 mm for capital letters of a corresponding font, evaluating the space available in each designated growth direction (north, south, east, west), and confirming that grouped elements maintain consistent sizing. This pre-rendering measurement ensures that when the metadata and tag interface agent 125 applies the transformations to the live interface, the scaled elements will fit properly within their designated spaces while maintaining readability.

The metadata and tag interface agent 125 works in coordination with the screen tag manager 114 to implement the dynamic transformations. When a sight accessibility option is selected, the metadata and tag interface agent 125 retrieves the tagged screen data and metadata from screen tag manager 114 for the current screen being rendered. The metadata and tag interface agent 125 then analyzes the metadata tags to determine which interface elements can be modified, their growth directions, grouping relationships, and any truncation constraints before applying the transformations.

FIG. 1B is a flow diagram 100-1 for truncating words in screens of a transaction interface, according to an embodiment. The screen tag manager 114 processes truncation rules on interface elements associated with words in a given screen of transaction interface 124.

The screen tag manager 114 does not process any word of screen data associated with a screen if that word is associated with metadata or a tag indicating that the word is not permitted to be truncated. That is, just words that are flagged as being capable of being truncated are processed by screen tag manager 114 when, because of text scaling within a given grouping of interface elements, it is necessary to truncate certain words. Truncation is not processed when there is no space constraint for a given word within a given grouping of interface elements of a screen.

The text truncation rules are as follows. If a widest word within a grouping of interface elements does not fit horizontally within the screen space constraints, the last word in the text is permitted to start losing letters for remeasurement. If any letter of a truncated word is removed, it is replaced with an ellipsis character (e.g., “. . . ”). For readability, no word is allowed to go below 3 letters in any natural written and spoken language.

As the screen tag manager 114 processes each group within the screen data for a screen, the screen tag manager 114 keeps measuring size and removing letters based on the truncation rules until a truncated word fits within the space constraints. 3 letters and an ellipsis in the space allowed is the maximum size for the word in the horizontal space. If there is an extra space, word wrap is enabled with the rule applying to the widest word. If the vertical space is exceeded for a given grouping of interface elements, the font size is limited to fill the horizontal space.

As an example, at 100-1-1, the screen tag manager 114 increases font size of a word. At 100-1-2, the screen tag manager 114 measures size of rendered text. At 100-1-3, the screen tag manager 114 checks to see if the text fits within the space constraints of the screen. When the text does not fit, at 100-1-4, the screen tag manager 114 truncates and shrinks the word using the truncation rules and iterates to 100-1-2. When the text does fit, at 100-1-5, the screen tag manager 114 shows or represents the word within the screen data for the screen. For example, the word “BEVERAGES” is shown or represented within the screen data as “BEV . . . ”.

FIG. 1C is an example interface screen 100-2 illustrating text that is capable of being scaled up in size in a single direction within the screen, according to an example embodiment. Screen 100-2 illustrates an example welcome screen shown on a display of an SST 120 before a transaction is initiated. The screen data for this screen and the tags and metadata can be modified such that the welcome screen itself is accessible to sight challenged customers.

100-2-1 illustrates a logo or brand reduced to a smaller size. Notably, the smallest permissible size for a given logo or brand can be deployed within the screen. The smallest permissible size for the logo or brand may be dictated by the owner of the logo or brand.

100-2-2 illustrates a greeting such as “Welcome,” which is already big enough and at least 9.5 mm in size but the size can be grown upward in other languages which have longer versions for welcome than does the English language. 100-2-3 illustrates an interface grouping of words that can be increased in size and grown downward.

100-2-4 illustrates an interface element, such as a search icon that can be deemed non-essential and therefore dropped entirely to provide more space for 100-2-5. When the search icon is dropped the font size of “search or key in item” can be grown upward to accommodate a larger font size.

FIG. 1D is an example interface screen 100-3 illustrating groupings of text for which text sizes within each grouping includes same font size as a largest measurable text size within a corresponding grouping, according to an example embodiment. Screen 100-3 illustrates a particular transaction state screen within transaction interface after a customer has scanned an item for purchase at the SST 120 during a self-checkout.

100-3-1 illustrates a smaller sized logo or brand name that may be used to reduce space if needed, assuming the smaller sized logo or brand is permissible. 100-3-2 illustrates a situation where icons for the item and other icons associated with the purchased item are hidden and the item description grows downward within the grouping. 100-3-3 illustrates related selectable options or functions on the screen, such as assistance that can grow in width by increasing the button size for visibility to the customer. 100-3-4 illustrates an easy to identify accessibility button, which may include a distinctive blue color to make it stand out to the customer during the transaction. 100-3-5 illustrates other selectable options or functions can be represented by a “More” button to accommodate over to more large text buttons for these other selectable options or functions.

100-3-6 illustrates that the word “Pay” can be hidden if the price font is too big since the dollar amount is more significant than the word “Pay” that precedes the dollar amount. 100-3-7 illustrates that the tax and total interface element grouping can be increased in size by growing it upward. 100-3-8 illustrates that each line item detail for the transaction can grow downward via scrolling within the screen to accommodate larger font sizes for the line item detail. 100-3-9 illustrates a selectable screen option labeled “Edit cart”. When this is selected, it expands to multiple lines and increases vertical size of corresponding text.

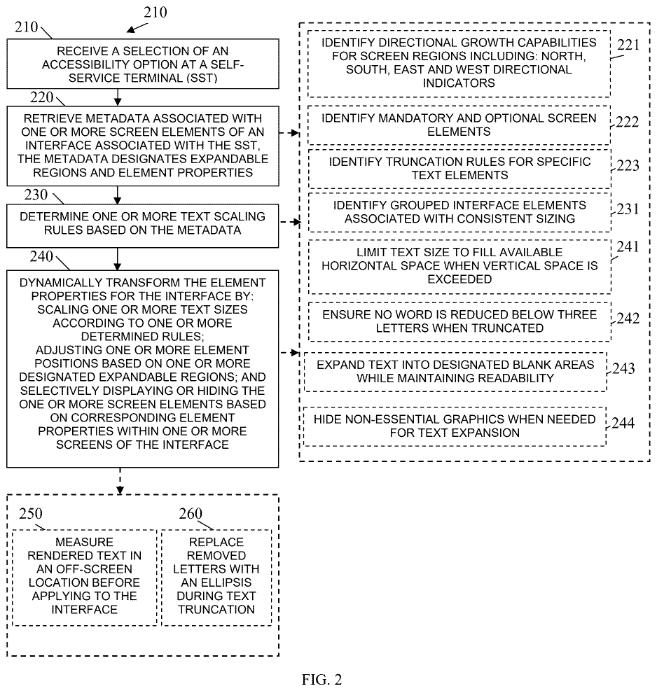

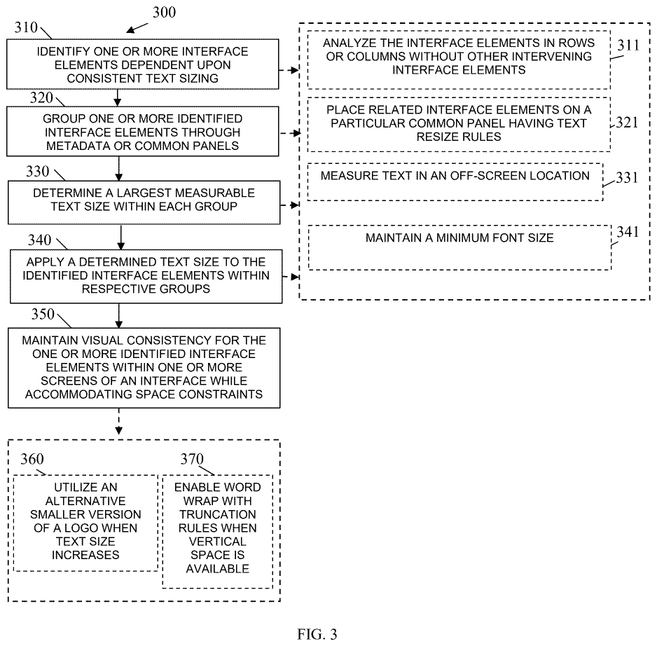

The interface screens described above demonstrate how the adaptive text scaling system dynamically modifies interface elements based on metadata tags and rules. The specific methods illustrated in FIGS. 2 and 3 provide the detailed processes for implementing these transformations, including how interface elements are identified, grouped, measured, and scaled while maintaining visual consistency and usability. These methods work in concert with the metadata tags and rules to ensure customers who are sight challenged can effectively complete transactions on SSTs 120.

FIG. 2 is a flow diagram of a method 200 for adaptive text scaling for visual accessibility on SSTs 120, according to an example embodiment. The software module(s) that implements the method 200 is referred to as a “sight accessibility interface manager.” The sight accessibility interface manager is implemented as executable instructions programmed and residing within memory and/or a non-transitory computer-readable (processor-readable) storage medium and executed by one or more processors of one or more devices. The processor(s) of the device that executes the sight accessibility interface manager are specifically configured and programmed to process the sight accessibility interface manager. The sight accessibility interface manager may have access to one or more network connections and the connections may be wired, wireless, or a combination of wired and wireless.

In an embodiment, the device that executes sight accessibility interface manager is an SST 120. In an embodiment, cloud 110 and SST 120 execute the sight accessibility interface manager. In an embodiment, the sight accessibility interface manager is all or some combination of screen tag interface 113, screen tag manager 114, transaction system 115, transaction manager 123, transaction interface 124, and/or metadata and tag interface agent 125.

At 210, sight accessibility interface manager receives a selection of an accessibility option on at an SST 120. At 220, the sight accessibility interface manager retrieves metadata associated with one or more screen elements of an interface associated with the SST 120. The metadata designates expandable regions and element properties.

In an embodiment, at 221, the sight accessibility interface manager identifies directional growth capabilities for screen regions. The directional growth capabilities include north, south, east, and west directional indicators.

In an embodiment, at 222, the sight accessibility interface manager identifies mandatory and optional screen elements. In an embodiment, at 223, the sight accessibility interface manager identifies truncation rules for specific text elements.

At 230, the sight accessibility interface manager determines one or more text scaling rules based on the metadata. In an embodiment, at 231, the sight accessibility interface manager identifies grouped interface elements associated with consistent sizing.

At 240, the sight accessibility interface manager dynamically transforms the element properties for the interface, The sight accessibility interface manager scales one or more text sizes according to one or more determined rules. The sight accessibility interface manager adjusts one or more element positions based on one or more designated expandable regions. Furthermore, the sight accessibility interface manager selectively displays or hides the one or more screen elements based on corresponding element properties within one or more screens of the interface.

In an embodiment, at 241, the sight accessibility interface manager limits text size to fill available horizontal space when vertical space is exceeded. In an embodiment, at 242, the sight accessibility interface manager ensures no word is reduced below three letters when truncated. In an embodiment, at 243, the sight accessibility interface manager expands text into designated blank areas while maintaining readability. In an embodiment, at 244, the sight accessibility interface manager hides non-essential graphics when needed for text expansion.

In an embodiment, at 250, the sight accessibility interface manager measures rendered text in an off-screen location before applying to the interface. In an embodiment, at 260, the sight accessibility interface manager replaces removed letters with an ellipsis during text truncation.

FIG. 3 is a flow diagram of another method 300 for adaptive text scaling for visual accessibility on SSTs 120, according to an example embodiment. The software module(s) that implements the method 300 is referred to as a “transaction interface text scaling manager.” The transaction interface text scaling manager is implemented as executable instructions programmed and residing within memory and/or a non-transitory computer-readable (processor-readable) storage medium and executed by one or more processors of a device. The processors that execute the transaction interface text scaling manager are specifically configured and programmed for processing transaction interface text scaling manager. The transaction interface text scaling manager may have access to one or more network during operation, the networks may be wired, wireless, or a combination of wired and wireless.

In an embodiment, the device that executes the transaction interface text scaling manager is an SST 120. In an embodiment, cloud 110 and SST 120 execute the transaction interface text scaling manager. In an embodiment, the transaction interface text scaling manager is all or some combination of screen tag interface 113, screen tag manager 114, transaction system 115, transaction manager 123, transaction interface 124, metadata and tag interface agent 125, and/or method 200. The transaction interface text scaling manager presents another, and in some ways an enhanced processing perspective from that which was described above with method 200 of FIG. 2.

At 310, the transaction interface text scaling manager identifies one or more interface elements dependent upon consistent text sizing. In an embodiment, at 311, the transaction interface text scaling manager analyzes the interface elements in rows and columns without other intervening interface elements.

At 320, the transaction interface text scaling manager groups one or more identified interface elements through metadata or common panels for a given screen. In an embodiment, at 321, the transaction interface text scaling manager places related interface elements on a particular common panel that has text resize rules.

At 330, the transaction interface text scaling manager determines a largest measurable text size within each group. In an embodiment, at 331, the transaction interface text scaling manager measures text in an off-screen location.

At 340, the transaction interface text scaling manager applies a determined text size to the identified interface elements within respective groups. In an embodiment, at 341, the transaction interface text scaling manager maintains a minimum font size. In an embodiment, the minimum font size is 9.5 mm.

At 350, the transaction interface text scaling manager maintains visual consistency for the one or more identified interface elements within one or more screens of an interface while accommodating space constraints. In an embodiment, the interface is transaction interface 124.

In an embodiment, at 360, the transaction interface text scaling manager utilizes an alternative smaller version of a logo when text size increases. In an embodiment, at 370, the transaction interface text scaling manager enables word wrap with truncation rules when vertical space is available.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
receiving a selection of an accessibility option at a self-service terminal (SST) display;
retrieving metadata associated with one or more screen elements of an interface associated with the SST, wherein the metadata designates expandable regions and element properties;
determining one or more text scaling rules based on the metadata;
dynamically transforming the element properties for the interface by:
scaling one or more text sizes according to one or more determined rules;
adjusting one or more element positions based on one or more designated expandable regions; and
selectively displaying or hiding the one or more screen elements based on corresponding element properties within one or more screens of the interface.

2. The method of claim 1, wherein retrieving the metadata comprises identifying directional growth capabilities for screen regions comprising: north, south, east, and west directional indicators.

3. The method of claim 1, wherein retrieving the metadata comprises identifying mandatory and optional screen elements.

4. The method of claim 1, wherein retrieving the metadata comprises identifying truncation rules for specific text elements.

5. The method of claim 1, wherein determining the one or more text scaling rules comprises identifying grouped interface elements associated with consistent sizing.

6. The method of claim 1, wherein scaling the one or more text sizes comprises limiting text size to fill available horizontal space when vertical space is exceeded.

7. The method of claim 1, wherein scaling the one or more text sizes comprises ensuring no word is reduced below three letters when truncated.

8. The method of claim 1, wherein adjusting the one or more element positions comprises expanding text into designated blank areas while maintaining readability.

9. The method of claim 1, wherein selectively displaying comprises hiding non-essential graphics when needed for text expansion.

10. The method of claim 1, further comprising measuring rendered text size in an off-screen location before applying to the interface.

11. The method of claim 1, further comprising replacing removed letters with an ellipsis during text truncation.

12. A method, comprising:
identifying one or more interface elements dependent upon consistent text sizing;
grouping one or more identified interface elements through metadata tags or common panels;
determining a largest measurable text size within each group;
applying a determined text size to the one or more identified interface elements within respective groups; and
maintaining visual consistency for the one or more identified interface elements within one or more screens of an interface while accommodating space constraints.

13. The method of claim 12, wherein identifying the one or more interface elements comprises analyzing the one or more interface elements in rows or columns without other intervening interface elements.

14. The method of claim 12, wherein grouping comprises placing related interface elements on a particular common panel having text resize rules.

15. The method of claim 12, wherein determining the largest measurable text size includes measuring text in an off-screen location.

16. The method of claim 12, wherein applying the determined text size comprises maintaining a minimum font size.

17. The method of claim 12, further comprising utilizing an alternative smaller version of a logo when text size increases.

18. The method of claim 12, further comprising enabling word wrap with truncation rules when vertical space is available.

19. A system, comprising:
a self-service terminal (SST) having a display;
a processor; and
memory having instructions that when executed cause the processor to:
receive an accessibility selection;
retrieve metadata for one or more interface elements;
apply one or more text scaling rules based on the metadata; and
dynamically transform one or more interface screens rendered on the display for a transaction at the SST while maintaining usability based on processing of the one or more text scaling rules.

20. The system of claim 19, wherein the instructions further cause the processor to maintain a minimum text size of 9.5 mm.
